(19) United States
(12) Patent Application Publication
(10) Pub. No.: US 2007/0104485 A1
(43) Pub. Date: May 10, 2007

(54) Device and method for transmitting data traffic in optical transport network

(75) Inventor: Jianmei Zhang, Guangdong (CN)

Correspondence Address: WOOD, PHILLIPS, KATZ, CLARK & MORTIMER, 500 W. MADISON STREET, SUITE 3800, CHICAGO, IL, 60661, US

(73) Assignee: Huawei Technologies Co., Ltd.

(21) Appl. No.: 11/584,973

(22) Filed: Oct. 23, 2006

Related U.S. Application Data
(63) Continuation of application No. PCT/CN05/02197, filed on Dec. 15, 2005.

(30) Foreign Application Priority Data
Dec. 15, 2004 (CN) 200410104256.3

(51) Int. Cl. H04J 14/00

(52) U.S. Cl. 398/69

(57) ABSTRACT

A device and a method for transmitting data traffic in an OTN are disclosed. First, all the time slots in the payload area of an OTN frame are allocated to sub-domains with certain bandwidth; then, the sub-domains are grouped into sub-domain groups to carry data traffic based on the bandwidth demand of various data traffic. The device and method provided in the present invention map the data directly on the OTN frame after encapsulating the data traffic so as to effectively avoid the redundant overhead and processing in the intermediate network hierarchies; and the bandwidth utilization is increased as much as possible by means of sub-domain and bandwidth allocation in the payload area of the OTN frame.

### CROSS-REFERENCE TO RELATED APPLICATIONS

This application is a continuation application of International Application No. PCT/CN2005/002197, filed Dec. 150, 2005, which claims priority in Chinese Application No. 2004-10104256.3, filed Dec. 15, 2004, both of which are entitled “Device and Method for Transmitting Data Traffic in Optical Transport Network”. The full disclosures of these applications are hereby incorporated by reference.

### FIELD OF THE TECHNOLOGY

The present invention relates to data transmitting technology in Optical Transport Network (OTN), and more particularly, to a device and a method for transmitting data traffic in the OTN.

### BACKGROUND OF THE INVENTION

Along with the development of information technology, various new services have come up. In particular, the mushrooming of Internet Protocol (IP) services not only brings great changes to people's life, but also deeply influences all the aspects of telecommunication networks. By now, the number of IP users across the world has exceeded 300 million, and such a situation has made data services, especially IP services, gradually replace voice services and become one of the major services of telecommunication networks, which results in an ineluctable transformation of telecommunication networks from traditional telephony networks to telecommunication networks focused on data services. The development tendency requires the future transmission networks to support a dynamic bandwidth allocation, an effective routing, an accurate detection of network or link failure and performance deterioration, and an instant recovery. A new transmission system is needed to fulfill the transmitting demands of the above data traffic in order to accommodate the future development of data services. The emergence of the OTN exactly meets the needs. The OTN provides a solid foundation for instant protection and recovery on the optical layer as well as the switching on optical paths. Compared with the traditional Synchronous Digital Hierarchy (SDH) and Wavelength Division Multiplexing (WDM) technology, the OTN, which combines electric layer multiplexing technology and optical layer technology, has such advantages as extremely strong forward error correction (FEC) capability, multi-level layer management function, transparent transport ability for almost all user signals, and perfect performance and malfunction management in optical channels.

Aiming at the irresistible development of the OTN, International Telecommunication Union—Telecommunication Standardization Sector (ITU-T) has already issued OTN serial recommendations, ITU-T G.709, G.798 and G.87X, and OTN products are coming into commercial use. Among the recommendations, G.709, put forward in February 2001, is the most important one; and the core of this recommendation is the digital wrapper technology. The digital wrapper defines a special frame format which encapsulates the client traffic into a payload unit of a frame, providing overhead (OH) bytes at the head of the frame for operation, administration, maintenance and provision (OAM&P) and providing FEC bytes at the end of frame for frame verification.

A standard frame format adopted by the digital wrapper technology is illustrated in FIG. 1. It can be seen that the standard frame of the digital wrapper technology adopts a frame format with 4 rows and 4080 columns. The 16 columns at the head of the frame are overhead bytes, the 256 columns at the end of the frame are FEC bytes, and the 3808 columns in the middle are payloads. In the overhead byte at the head of the frame, the first 7 columns in the 1^{st} row are bytes of frame alignment signal (FAS); the 8^{th} to 14^{th} columns are level K optical channel transport unit (OTU) overhead bytes, the value of K equals to 1, 2 or 3 and stands for different rate; the first 14 columns in the 2^{nd} to 4^{th} rows are optical channel data unit (ODU) overhead bytes, the 15^{th} column and 16^{th} column are optical channel payload unit (OPU) overhead bytes.

In the frame, the OTUk overhead bytes provide monitoring functions, i.e. Reamplification, Reshaping and Retiming (3R) function, for the transmitting signal status of the regeneration nodes in the OTN To be specific, the OTUk overhead bytes include section monitoring (SM) overhead bytes, general communication channel (GCC0) overhead bytes and reserved (RES) overhead bytes.

The ODUk overhead bytes provide cascading connection monitoring, end-to-end channel monitoring and client traffic adaptation via OPUk, including: Path Monitoring (PM) overhead bytes, Tandem Connection Monitoring (TCM) overhead bytes, General Communication Channel (GCC) overhead bytes, Auto-Protection Switching/Protection Control Channel (APS/PCC) overhead bytes, Fault Type Fault Location (FTFL) information, Experiment (EXP) overhead bytes, and etc.

The OPUk includes payloads and relevant overheads. The relevant overhead bytes include Payload Structure Identifier (PSI) and other reserved bytes (RES).

In the prior art, there are usually two solutions to data traffic mapping on the OTN frame structure.

The first solution is mapping through SDH. First, data traffic is encapsulated through the encapsulating methods such as generic framing procedure (GFP), and then is mapped on virtual containers (VC) of the SDH. The VCs of different levels adopt different bandwidths, therefore different bandwidth is assigned to different data traffic and thus virtual concatenation groups and SDH frames are generated. Finally, the VCs are adapted into the OTN frame structure through the method for mapping SDH on OPUk defined in G.709.

This solution involves many network hierarchies including the GFP encapsulating, the SDH VC and virtual concatenation, the OTN frame structure, and etc., which results in not only a redundancy in frame structure overhead, but also extra resource consumptions are introduced in the processing on various network hierarchies.

The second solution is to map the data traffic directly to an optical channel (OCh) in the OTN in a pure data traffic mode. The data are directly mapped to the OCh payload unit OPUk in the OTN after GFP encapsulation.

Though by this solution, the problem of involving multiple network hierarchies is avoided and the transmitting efficiency is improved, it causes immoderate bandwidth allocation which further results in a resource waste. In fact, the bandwidth of the data traffic is usually far narrower than the narrowest OPU1 bandwidth, therefore massive GFP idle frames are needed for rate adaptation, and thus the performance of the system is poor. For example, in the Gigabit Ethernet (GE) traffic, the original data rate is 1 Gbps, the bandwidth of GFP frame after line coding, verification and GFP encapsulating is around 1.0495 Gbps, while the bandwidth of the payload of the OPU1 is 2.488320 Gbps, therefore the bandwidth utilization is only 1.0495/2.488320=42%. The bandwidth utility ratio is even lower when transmitting other data traffic such as the fiber channel (FC) traffic. In actual implementations, therefore, the above solutions bring such problems as a complicated network structure, an inefficient frame encapsulating, massive processing resource consumptions, low transmitting efficiency, and low bandwidth utilization.

### SUMMARY OF THE INVENTION

An embodiment of the present invention provides a data traffic transmitting device in the OTN to realize high efficient data traffic mapping on the OTN frame structure.

A corresponding data traffic transmitting method in OTN is also provided by an embodiment of the present invention for realizing high efficient data traffic mapping on the OTN frame structure and increasing the bandwidth utilization in the system.

The OTN data traffic transmitting device in an embodiment of the present invention includes: at least one data traffic encapsulating module, a sub-domain mapping module, and an OTN framing module; wherein, the at least one data traffic encapsulating module is configured to encapsulate the data traffic from the client and output the encapsulated data traffic to the sub-domain mapping module; the sub-domain mapping module is configured to divide the OTN frame payload domain into at least one sub-domain, put one or a plurality of sub-domains into one or a plurality of sub-domain groups, and map the encapsulated data traffic on the sub-domain group(s) before outputting the sub-domain group(s) to the OTN framing module; and the OTN framing module is configured to generate an OTN frame based on the OTN frame payloads outputted by the sub-domain mapping module.

The embodiment also provides a receiving device for transmitting data traffic in the OTN, including: an OTN framing module, a sub-domain mapping module and at least one data traffic encapsulating module. In the device, the OTN framing module is configured to analyze the OTN frame received from OTN and obtain the payloads of the OTN frame; the sub-domain mapping module is configured to restore the data traffic from the corresponding sub-domain group(s) of the OTN frame payloads which are outputted from the OTN framing module; and the data traffic encapsulating module(s) is(are) configured to de-encapsulate the data traffic from the sub-domain mapping module and output them to corresponding client(s), respectively.

An embodiment of the present invention also provides a method for transmitting data traffic in the OTN, which includes:

dividing an OTN frame payload domain into at least one sub-domain; and

encapsulating at least one path of data traffic from client(s), and mapping the encapsulated data traffic, respectively, on one or more corresponding sub-domain groups which include at least one sub-domain, wherein the sub-domain group(s) carries (carry) the data traffic, respectively, and form an OTN frame.

A method for receiving data traffic in the OTN is also provided in an embodiment of the present invention, including: analyzing the OTN frame received; restoring a single or a plurality of data traffic from one or more sub-domain groups in the OTN frame payload area; de-encapsulating the single or plurality of data traffic; and transmitting the data traffic to corresponding client port respectively.

The method further includes: separating the OTN frame overhead from the OTN frame received, obtaining the data traffic-related information from the OTN frame overhead, and restoring a single or multiple data traffic from one or more sub-domain groups in the OTN frame payload area based on the data traffic-related information.

It can be seen from the foregoing description that the device and the method provided by the embodiments of the present invention directly map the data on the OTN frame after encapsulating the data traffic so as to effectively avoid the redundant overhead and processing in the intermediate network hierarchies; and the bandwidth utilization is increased as much as possible through sub-domain division and bandwidth allocation in the OTN frame payload area.

### BRIEF DESCRIPTION OF THE DRAWINGS

FIG. 1 is a schematic diagram illustrating a standard frame format in the digital wrapper technology;

FIG. 2 is a schematic diagram illustrating the structure of the device for transmitting data traffic in the OTN according to a preferred embodiment of the present invention;

FIG. 3 is a flow chart of the method for transmitting data traffic in the OTN according to a preferred embodiment of the present invention;

FIG. 4 is a flow chart of the method for receiving data traffic in the OTN according to a preferred embodiment of the present invention;

FIG. 5 is a schematic diagram illustrating sub-domain dividing by interleaving and a kind of mapping relationships between sub-domain groups and data traffic according to a preferred embodiment of the present invention;

FIG. 6 is a schematic diagram illustrating the mapping relationships between sub-domain groups and data traffic according to a preferred embodiment of the present invention;

FIG. 7 is a schematic diagram illustrating the filling of data traffic-related information in reserved bytes in the overhead area of the OTN frame according to a preferred embodiment of the present invention;

FIG. 8 is a schematic diagram illustrating the filling of data traffic-related information in reserved bytes in the overhead area of the OTN frame according to another preferred embodiment of the present invention;

FIG. 9 is a schematic diagram illustrating the filling of data traffic-related information in reserved bytes in the overhead area of the OTN frame according to still another preferred embodiment of the present invention;

FIG. 10 is a schematic diagram illustrating the location coding of various data traffic in the overhead area of the OTN frame according to yet another preferred embodiment of the present invention;

FIG. 11 is a schematic diagram illustrating the mapping of 4 types of data traffic into the payload area of OPU1 according to a preferred embodiment of the present invention.

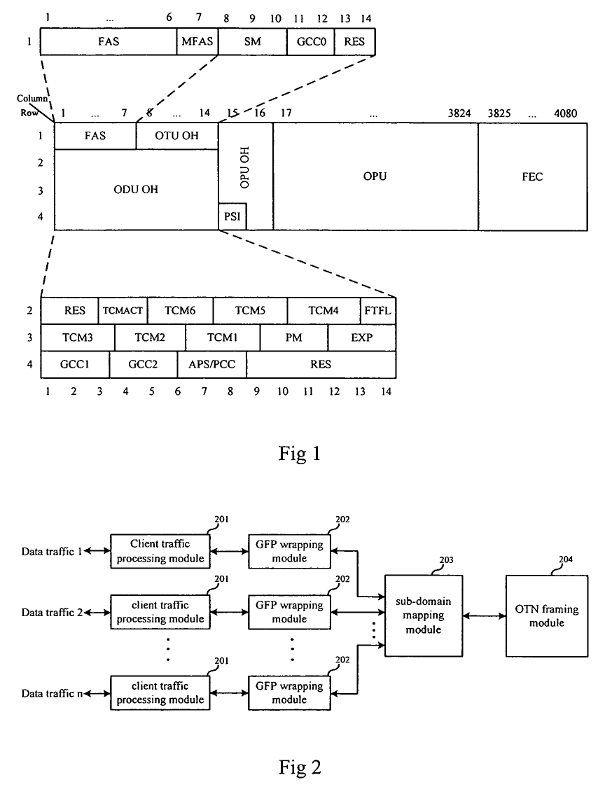

### DETAILED DESCRIPTION OF THE INVENTION

Preferred embodiments of the present invention are hereinafter described in detail with reference to accompanying drawings.

First, a preferred embodiment of the present invention provides a device for transmitting data traffic in the OTN. FIG. 2 illustrates the structure of the device for transmitting data traffic in the OTN based on the embodiment. As shown in FIG. 2, the device includes at least one client traffic processing module 201, and at least one GFP encapsulating module 202 which is one-to-one corresponding to the client traffic processing module 201, a sub-domain mapping module 203 and an OTN framing module 204.

In the device, each client traffic processing module 201 is located between a client and the corresponding GFP encapsulating module 202 for receiving and transmitting data traffic from the client and performing physical layer functions related to the data traffic from the client, e.g., optical/electrical or electrical/optical signal conversion and interface conversion when the type of the client signal is different from the type of the signal processed by the OTN device. Besides, the client traffic processing module 201 is in charge of pre-processing the data traffic before encapsulating or post-processing the data traffic after de-encapsulating, e.g., physical coding sub-layer (PCS) processing, line coding and decoding, and etc., wherein the line coding and decoding may adopt the line coding solution of 8 B/10 B.

The GFP encapsulating module 202 is located between the corresponding client traffic processing module 201 and the sub-domain mapping module 203. On one hand, the GFP encapsulating module 202 encapsulates through GFP the data traffic which has been pre-processed by the corresponding client traffic processing module 201; on the other hand, the GFP encapsulating module 202 de-encapsulates the traffic from the sub-domain mapping module 203.

The GFP encapsulating is encapsulating data traffic in a generic encapsulating format, which includes two modes: GFP frame mapping (GFP-F) and GFP transparent mapping (GFP-T). In the GFP-F mode, each data frame is encapsulated and GFP header information is added to the frame; in the GFP-T mode, frames are processed on the basis of data block and the processing of each complete data frame is not needed. Therefore, in the GFP-T mode, the length of GFP payload is fixed and the processing of complete data frames is not needed. As a result, the GFP-T mode, in which the GFP payload length is fixed and the processing of complete data frames is not needed, is often adopted in delay-sensitive applications such as in a storage network; while the GFP-F mode is often adopted in other applications.

In the preferred embodiment of the present invention, the GFP-F or the GFP-T mode can be chosen in the encapsulating process according to the needs of data traffic. It should be noted that the present embodiment may employ other encapsulating method as well as the GFP encapsulating method, such as high-speed data link control (HDLC) or link access procedure SDH (LAPS). Different data traffic encapsulating modules shall be employed based on different encapsulating methods, e.g., HDLC encapsulating modules or LAPS encapsulating modules may replace the GFP encapsulating modules shown in FIG. 2. The processing in these encapsulating modules is similar to that of the GFP encapsulating modules 202, and will not be described herein.

The sub-domain mapping module 203 is the key module in the technical scheme of the present embodiment, it is located between the GFP encapsulating module(s) 202 and the OTN framing module 204 and is configured to divide the payload area of an OTN frame into one or multiple sub-domains (SD) and map the encapsulated data traffic to the sub-domain group(s), each of which includes at least one sub-domain to achieve a high bandwidth utilization.

As described above, the payload area of an OTN frame includes 3808 columns, wherein each column is called a time slot (TS), and each time slot, which is the smallest unit of the payload area dividing, includes 4 bytes from row 1 to row 4. A sub-domain occupies a bandwidth, which is composed of multiple time slots, and is the smallest unit of the bandwidth dividing. The time slots composed in each sub-domain can be successive or column interleaved. Sub-domains are defined mainly for various data traffic to share the OTN frame bandwidth and realize high efficiency in carrying data traffic. Generally speaking, each sub-domain includes the same number of time slots, and the bandwidth that a sub-domain can carry is the smallest unit of bandwidth allocation. For example, the bandwidth rate of the payload area of OPU1 is 2488320 kbps, if a sub-domain includes 17 time slots, the bandwidth of a sub-domain shall be 2488320×17/3808=1.10857 Mbps. The sub-domain mapping module 203 groups one or more sub-domains to obtain sub-domain groups. Each sub-domain group includes at least one sub-domain and carries corresponding data traffic, which is to fill the encapsulated data traffic into the bytes in the sub-domain group. For example, a GFP-T encapsulated GE traffic (4 bytes of payload extension header and 4 bytes of CRC-32 verification area are added) needs a bandwidth of 1.0495 Gbps. Providing that a sub-domain includes 17 time slots, and then at least 1.0495G/11.10857M=95 sub-domains are needed to transmit the GFP-T encapsulated GE traffic. Therefore, the sub-domain mapping module 203 may use the first 95 sub-domains to fill this GE traffic during the mapping procedure.

In another preferred embodiment of the present invention, the sub-domain mapping module 203 further includes: an overhead processing sub-module, which fills the overhead area of the OTN frame with data traffic-related information so that the receiving end can receive and process the OTN frame based on the information. Herein, the data traffic-related information includes: the number of the data traffic, the number of the sub-domains, the mapping relationship(s) of the sub-domain group(s) and the data traffic, and etc. When the transmitting end and the receiving end have not made an agreement in advance on the sub-domain allocation method and traffic mapping relationship(s), the transmitting end needs to fill such information in the reserved bytes of the pre-agreed OTN frame overhead area. The receiving end needs to analyze the data traffic-related information sent by the transmitting end in the reserved bytes by the overhead processing sub-module so that the sub-domain mapping module can restore the data traffic carried by the sub-domain groups in the payload area of the OTN frame.

The OTN framing module 204 completes the final steps of the OTN framing. In the transmitting procedure, it fills the overhead area of the OTN frame, attaches FEC verification bytes, generates the OTN frame and transmits the OTN frame on the optical layer of the OTN; in the receiving procedure, it performs the reversed analysis on the OTN frame, including: separating the overheads and payloads from the received OTN frame after a successful FEC verification.

The dynamic working process of the device in the data traffic transmitting process is hereinafter described in details with reference to FIG. 2 to further expound the inter-collaboration of the functions of the device according to an embodiment of the present invention.

In the transmitting direction, first, at least one client on the bearer sends client signals, which are data traffic, to the corresponding client traffic processing module(s) 201. Each client traffic processing module completes the optical/electrical conversion, PCS processing and line coding before outputting the traffic to the corresponding GFP encapsulating module 202.

Then the GFP encapsulating module 202 encapsulates the received data traffic according to the GFP format, e.g., GFP frame headers and verification fields are added, and then the encapsulated data traffic is outputted to the sub-domain mapping module 203.

After that, the sub-domain mapping module 203 collects the data traffic from all the GFP encapsulating module(s) 202, and completes a sub-domain division and mapping in the OTN frame. The sub-domain division and mapping procedure shall be completed in consideration of several factors including the bandwidth allocation accuracy and the bearer bandwidth demands. Then the data traffic is filled in corresponding sub-domain groups while the overhead processing sub-module fills the data traffic-related information, which is generated in the sub-domain mapping process, in the pre-agreed reserved bytes in the overhead area of the OTN frame; thereafter, the payloads and the overheads are outputted to the OTN framing module 204.

Finally, the OTN framing module 204 completes the final steps of the OTN framing, generates the OTN frame and transmits the generated OTN frame in the OTN.

In the receiving direction, accordingly, first, the OTN framing module 204 receives the OTN frame, analyzes and obtains the overheads and payloads of the OTN frame while conducting the OTN frame verification. When the OTN frame verification is successful, the overheads and payloads are outputted to the sub-domain mapping module 203;

Then the sub-domain mapping module 203 restores all the data traffic from the payload area of the OTN frame, with reference to the data traffic-related information analyzed from the overheads by the overhead processing sub-module. The restored data traffic is sent to corresponding GFP encapsulating module(s) 202 respectively;

Each GFP encapsulating module 202 carries out GFP de-encapsulating of the data traffic and output the data traffic to the corresponding client traffic processing module 201;

Finally each client traffic processing module 201 completes the final processing steps including the line decoding, the PCS processing and the electrical/optical conversion, and send the data traffic to the corresponding client.

Hereinafter, the method provided in an embodiment of the present invention for transporting data traffic in the OTN is described in details with reference to preferred embodiments of the present invention.

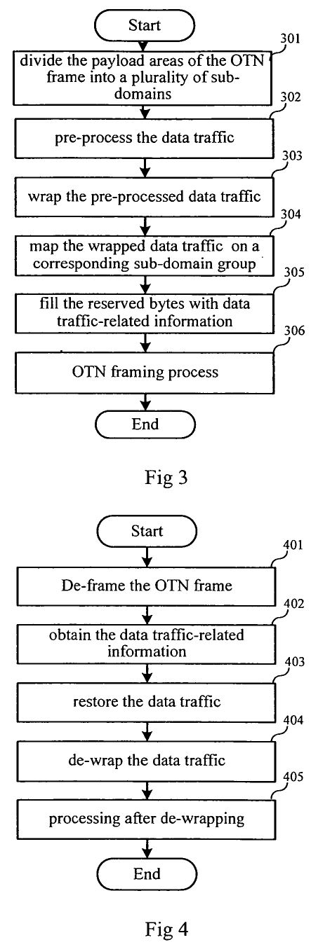

FIG. 3 is a flow chart illustrating the method for transmitting data traffic in the OTN based on a preferred embodiment of the present invention. As it is illustrated in FIG. 3, the following steps are executed in the transmitting process of data traffic:

Step 301: combine the time slots in the payload area of an OTN frame into at least one sub-domain.

As is described above, the OTN frame includes an OTU overhead area, an ODU overhead area, and an OPU overhead area, an OPU payload area and an FEC verification area. The OPU payload area includes 3808 columns; each of these columns is a time slot. The bandwidth of a time slot is 1/3808 the bandwidth of the whole OPU payload area. If the payload area is allocated based on time slots, the procedure will be too complicated. Therefore, in a preferred embodiment of the present invention, the time slots are combined into multiple larger sub-domains and the payload area is allocated based on sub-domains, thus the payload area allocation shall turn to be simple and effective.

Step 302: make a pre-processing of the data traffic from the client(s) before encapsulating.

The data traffic may include Ethernet traffic, such as GE traffic and Fast Ethernet traffic; storage traffic, such as FC traffic and enterprise systems connection (ESCON) traffic; and video traffic, such as digital video broadcast-asynchronous serial interface (DVB-ASI) traffic.

The detailed pre-processing procedure in this step includes: performing an optical/electrical conversion, an interface conversion, a PCS processing and a line decoding to the client traffic received. The line coding may adopt common line coding methods such as 8 B/10 B.

Step 303: encapsulate the pre-processed data traffic.

As the GFP encapsulating could adapt the data traffic to the OTN frame efficiently while supporting OAM&P management functions, which therefore offers a great help to a reliable transport of data traffic in the network, the GFP encapsulating, including the GFP-T and the GFP-F, is adopted in a preferred embodiment of the present invention. Other encapsulating methods such as the HDLC and the LAPS are obviously acceptable for the data traffic encapsulating and are covered by the protection scope of the present invention.

Step 304: group the sub-domain(s) obtained in Step 301 into at least one sub-domain group based on the bandwidth demands of the encapsulated data traffic, each sub-domain group forms a bearer area corresponding to a type of data traffic. The encapsulated data traffic is mapped on and carried by the corresponding sub-domain group to form the payloads of the OTN frame.

The grouping of sub-domain(s) can be based on the bandwidth demands of various kinds of data traffic and the bandwidths of the sub-domain(s). Typically, the bandwidth of a sub-domain group is a little larger than the bandwidth demand of the data traffic it carries. Besides, in the mapping procedure, the allocation of sub-domain group(s) for data traffic can be done in any order, e.g., the sub-domain group(s) can be allocated to data traffic which needs to be carried from the first column of the OPU payload area according to the sequence of the data traffic.

Step 305: fill the reserved bytes of the OTN frame overhead with data traffic-related information, the data traffic-related information mainly includes: the number of the data traffic, the number of the sub-domains and the mapping relationship(s) of the sub-domain group(s) and the data traffic, etc.

The detailed rules of filling in the above step may be agreed in advance by the transmitting end and the receiving end.

In an embodiment of the present invention, the transmitting end needs to transmit the data traffic-related information through the OTN frame to the receiving end because the number of data traffic may change dynamically, therefore the transmitting end needs to fill in the reserved bytes of the overhead area of the OTN frame, such as the RES in the PSI area of the OPU OH, with the data traffic-related information including the number of the data traffic, the number of the sub-domains and the mapping relationship(s) of the sub-domain group(s) and the data traffic so that the receiving end can analyze the content of the reserved bytes in the overhead area of the OTN frame to obtain the data traffic-related information and thereafter correctly restores the data traffic of various types from the OPU payload area.

Step 306: carry out the OTN framing process based on the OTN frame structure. Add the overhead area and the FEC verification area to form a complete OTN frame for transmission in the OTN.

FIG. 4 is a flow chart illustrating the method for receiving data traffic in the OTN based on a preferred embodiment of the present invention. As illustrated in FIG. 4, the following steps are executed in receiving data traffic:

Step 401: an OTN frame is analyzed based on the OTN frame structure to obtain the OPU payloads and overheads.

Step 402: the data traffic-related information is obtained from the reserved bytes of the OTN frame overheads.

The data traffic-related information, accordingly, includes: the number of the data traffic, the number of the sub-domains, and the mapping relationship(s) of the sub-domain group(s) and the data traffic.

Step 403: the data traffic is restored from the payloads of the OTN frame based on the analyzed information including the data mapping relationship(s) and etc.

Step 404: de-encapsulate the data traffic.

The de-encapsulating in this step can be the GFP-F, the GFP-T, the HDLC or the LAPS, depending on the encapsulating process in Step 303.

Step 405: make a post-operation for the de-encapsulated data traffic, including the line encoding, the PCS processing, the interface conversion and the electrical/optical conversion. Then the processed data traffic is sent to the corresponding client(s), respectively.

It can be seen from the foregoing description that the device and method provided in the two embodiments of the present invention directly map the data on the OTN frame after encapsulating the data traffic so as to effectively avoid redundant overheads and processing in the intermediate network hierarchies; and the bandwidth utilization is increased as much as possible through sub-domain division in the OTN frame payload area and bandwidth allocation. To be specific, in a preferred embodiment of the present invention, all the time slots in the payload area of the OPUk can be divided into sub-domain(s) with a certain bandwidth according to the bandwidth allocation demand; then the sub-domain group(s) is (are) allocated to various types of data traffic based on the bandwidth demands of the traffic so as to carry the matched data traffic while the information such as the mapping relationship(s) of the sub-domain group(s) and the data traffic is filled in the reserved bytes of the overhead area in the OTN frame so that the data traffic can be restored based on the relationship information of the sub-domain group(s) and data traffic when received.

The sub-domain allocation method in Step 301 is hereinafter described in details:

In a preferred embodiment of the present invention, the aim is to put all the time slots into the sub-domain(s) while each sub-domain includes enough bandwidth. For example, as the factorization of 3808 (columns) is 3808=14×16×17, every 14 or 16 or 17 time slots may be put into a sub-domain such that a proper sub-domain bandwidth could be obtained. In another example, the bandwidth of a time slot in the OPU1 is 2.488320 Gbps/3808=0.653445378 Mbps, therefore the bandwidth of a sub-domain including 14 time slots is 0.653445 Mbps×14=9.14824 Mbps; the bandwidth of a sub-domain including 16 time slots is 0.653445 Mbps×16=10.455126 Mbps and yet that of a sub-domain comprising 17 time slots is 0.653445 Mbps×17=11.10857 Mbps. Then in consideration of the sub-domain bandwidth obtained and the basic bandwidth that is needed by the carried traffic, the minimum sub-domain number that is needed for each path of the data traffic can be counted in Step 302 so that the sub-domain group(s) can be formed.

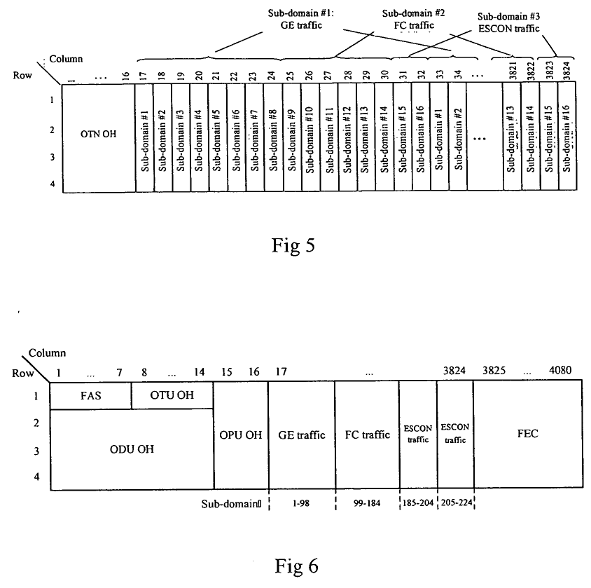

The payload area of the OPUk can be divided into sub-domain(s) sequentially. For example, if every 17 time slots is to form a sub-domain, the 17^{th} to the 33^{rd} columns of the OTN frame structure (the 1^{st} to the 17^{th} columns of the payload area of OPU1) forms the 1^{st} sub-domain, the 2^{nd} sub-domain includes the 34^{th} column of the OTN frame structure (the 18^{th} column of the payload area of OPU1) to the 50^{th} column of the OTN frame structure (the 34^{th} column of the payload area of OPU1), and the rest may be inferred until 224 sub-domains are eventually obtained. On the other hand, a payload area of the OPUk can be divided into multiple sub-domains sequentially through interleaving, which is to divide the payload area of the OPUk into multiple sub-domains and the sub-domains are located in the payload area of the OPUk in a pattern of interleaving. For example, providing that a payload area of the OPUk is divided into 16 sub-domains and the bandwidth of each sub-domain is OPU1/16, or 155.52 Mbps. Since there are 3808 columns in the payload area of the OPUk, each sub-domain occupies 238 columns (i.e. 238 time slots), e.g. the 17^{th} column of the OTN frame (the 1^{st} column of the payload area of OPU1) is assigned to Sub-domain #1, the 18^{th} column of the OTN frame (the 2^{nd} column of the payload area of OPU1) is assigned to Sub-domain #2, the 19^{th} column of the OTN frame (the 3^{rd} column of the payload area of OPU1) is assigned to Sub-domain #3, and the rest may be inferred until the 32^{nd} column is finally assigned to Sub-domain #16; then the time slots are again assigned circularly according to the above sequence, . . . , until the 3824^{th} is assigned to sub-domain #16. The details are illustrated in FIG. 5. As described above, GFP can be used to encapsulate the data traffic based on the encapsulating method in Step 303. The GFP Frame format includes the core header and the payload area. The core header identifies the length, the beginning position of a GFP frame; including two bytes of a payload length indicator (PLI) and two bytes of a CRC-16 core header error check (cHEC). The GFP payload area includes 4 to 64 bytes of a payload header, a client payload area and optional payload verification information. The payload header contains the basic information that identifies the payload information of the GFP frame, including the payload type and GFP encapsulating method. The payload header also contains an extension header area for which G.7041 protocol defines only three formats currently, namely, blank extension header, linear extension hear and circular extension header. According to the payload header format of the GFP linear frame, the 9^{th} byte in the header is the channel identifier (CID), it is stipulated in the G.7041 that the CID shall be used to identify each channel when multiple independent links need to be converged to a single channel. In a preferred embodiment of the present invention, the CID in a GFP frame is used to distinguish the port numbers of different data traffic. When transmitting the data traffic, different CIDs are assigned to the GFP-encapsulated client data traffic from different ports; when receiving data traffic, the CID is used to determine whether the GFP traffic restored from the OPU payload area is from the same port.

As described above, there are two GFP encapsulating modes, namely, the GFP-F and the GFP-T. As the bandwidth increment varies with different frame lengths after the GFP encapsulating when the GFP-F mode is adopted, the GFP-T mode is described herein in the embodiment of the present invention for sake of convenience. As recommended by G.7041, in GFP-T , the numbers of super blocks for GE, FC100 and ESCON are 95, 13 and 1, respectively; the header length in the GFP-T mode is 4 (core header)+4 (payload header)+4 (extension header)+4 (FCS area)=16 bytes; therefore the bandwidth of a GFP-T encapsulated GE traffic is approximately 1.0495 Gbps, the bandwidth of a path of FC100 traffic is approximately 906.1899 Mbps and the bandwidth of a path of ESCON traffic is approximately 207.5 Mbps.

In Step 304, the mapping of data traffic on the sub-domain group(s) is completely based on the bandwidth demands. For example, if the sub-domains are allocated sequentially, which means 17 continuous time slots in an OPU1 payload area form a sub-domain, the bandwidth of the sub-domain is 11.10857 Mbps. As described above, an encapsulated GE traffic needs at least 95 sub-domains to satisfy its bandwidth demand and additional sub-domains are needed for transmitting GFP management frames, therefore, a sub-domain group of 98 sub-domains, with a total bandwidth of 11.10857×98=1088.63986 Mbps>1049.5 Mbps, is used to carry a path of GE traffic. The processing method is the same for FC traffic that a sub-domain group of 86 sub-domains, with a total bandwidth of 11.10857×86=955.33702 Mbps>906.1899 Mbps, is used to carry a path of FC traffic. The sub-domain group which carries a path of ESCON traffic includes 20 sub-domains with a total bandwidth of 11.10857×20=222.1714 Mbps>207.5 Mbps. For another example, when the GE data traffic, the FC data traffic and 2 paths of ESCON data traffic are received in an OPU1, the GE traffic occupies 98 sub-domains, the FC traffic occupies 86 sub-domains and each path of the ESCON traffic occupies 20 sub-domains. All the 3808 time slots in the OPU1 are just occupied ((98+86+2×20)×17=3808). FIG. 6 illustrates the mapping relationships between the sub-domain groups and the data traffic when the GE data traffic, the FC data traffic and 2 paths of ESCON data traffic are received in an OPU1.

It should be noted that FIG. 6 illustrates only one embodiment of the present invention. When the sub-domains are allocated through interleaving, each client traffic port may occupy discontinuous sub-domains and therefore it may take sub-domains in any location. In such a situation, based on the bandwidth of received data traffic, multiple sub-domains are grouped into the sub-domain group(s) to map corresponding data traffic. For example, as the bandwidth of a GFP-encapsulated GE traffic exceeds 1 Gbps, 8 sub-domains are grouped into Sub-domain Group 1 (with a bandwidth of 155.52 Mbps×8=1.24416 Gbps) to carry the GE traffic; for a path of FC traffic, 6 sub-domains are grouped into a sub-domain group to carry the traffic; and 2 sub-domains are grouped into a sub-domain group to carry a path of ESCON traffic. FIG. 5 also illustrates the mapping relationships of the sub-domain groups and the data traffic when a path of GE traffic, a path of FC traffic and a path of ESCON traffic are carried by sub-domains that are obtained through interleaving. The sub-domain groups illustrated in FIG. 5 include neighboring sub-domains while it is understood by those skilled in the art that the sub-domain groups may also include disjunctive sub-domains.

This mapping method of data traffic on the sub-domain groups guarantee that the bandwidth that is occupied by each path of the traffic in an OPU1 frame is a little larger than the bandwidth of the traffic itself. In a preferred embodiment of the present invention, the difference between the allocated bandwidth and the actual bandwidth of a path of traffic can be adapted with idle frames or be used for transmitting GFP management frames. In another preferred embodiment of the present invention, the left unused time slots or sub-domains can be filled with fixed bytes and the receiving end will ignore such unused time slots or sub-domains.

The process in which data traffic-related information is filled into the reserved (RES) bytes in the overheads of the OTN frame, as it is described in Step 305, is explained hereinafter in details.

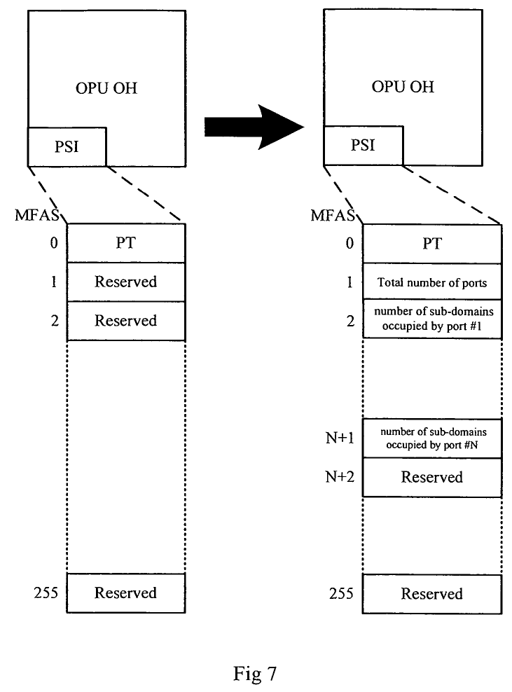

In a preferred embodiment of the present invention, the total number of the data traffic ports and the number of the sub-domains assigned to each traffic port can be carried with RES bytes in the PSI area of an OPU overhead. The PSI is a byte string (PSI[0]˜PSI[255]) with a repeating period of 256, the meaning of each byte is determined by the value of multi-frame alignment sequences (MFAS). When the value of MFAS is 0, PSI[0] is a payload-type (PT) area which identifies the traffic type carried in the payload area of the OPUk. G.709 has defined common traffic types at present and has not given terms on the situation when multiple paths of data traffic are mapped on one OPUk payload area. So a value in the reserved area between 0×80˜0×8 F can be used to indicate that the OPUk payload area contains a plurality of data traffic. An allocation of PSI string according to an embodiment of the present invention may be: PSI[1] contains variable N, which stands for the number of data traffic access ports, for example, when 4 client traffic are received, including a path of GE traffic, an path of FC traffic and 2 paths of ESCON traffic, the value of N shall be 4, and value 0×04 is assigned to the byte; the values of PSIs from PSI[2] to PSI[N+1] indicate the number of sub-domains that are occupied by the data traffic received from each port respectively. When Port #1 receives a path of GE traffic which occupies 98 sub-domains, the value 0×62 (equals to 98 in decimal system) is assigned to the corresponding PSI[2] of the frame in which the value of MFAS is 2 to indicate the number of the sub-domains; when Port #2 receives a path of FC 1G traffic which occupies 86 sub-domains, the value 0×56 (equals to 86 in decimal system) is assigned to the corresponding PSI[3] of the frame in which the value of the MFAS is 3 to indicate the number of the sub-domains; and when Port #3 & #4 receive 2 paths of ESCON traffic, each of which occupies 20 sub-domains, the value 0×14 (equals 20 in decimal system) is assigned to the corresponding PSI[4] and PSI[5] of the frames in which the values of the MFAS are 3 and 4, respectively, to indicate the number of the sub-domains. Thus the receiving end is able to restore each path of the data traffic properly, based on such information, from the sub-domains. FIG. 7 is a schematic illustrating the filling of data traffic-related information into the reserved bytes in the overhead area of the OTN frame according to the above preferred embodiment of the present invention.

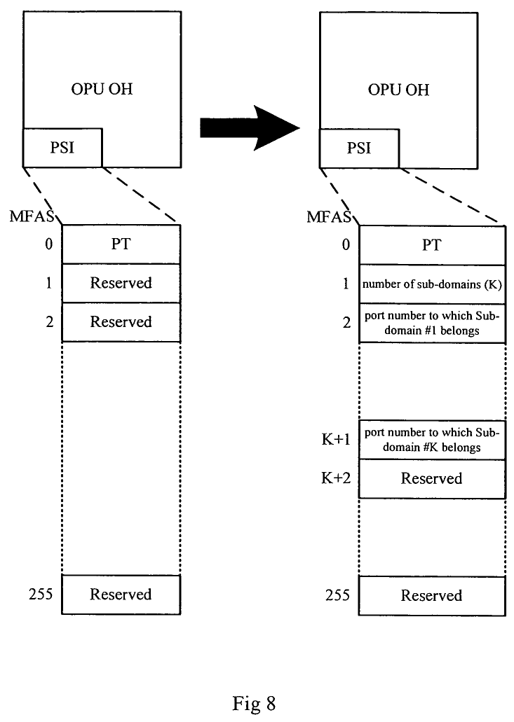

When the sub-domains are obtained through interleaving, the detailed method for filling the reserved bytes in the OTN frame overhead with data traffic-related information is as follows: use PSI in the overhead, when the value of MFAS is 0, the PSI[0] is area of payload type, indicating the type of the traffic carried in the OPUk payload area; PSI[1] contains variable K, indicating the number of the sub-domains in the OPUk payload area. In an embodiment of the present invention, the OPU1 payload area includes 16 sub-domains, therefore the value of PSI[1] is 0×10, the PSIs from PSI[2] to PSI[K+1] may include the information of the number of the port to which each sub-domain belongs to. In an embodiment of the present invention, sub-domains from No. 1 to No. 8 are assigned to one GE traffic port, therefore the values of the PSIs from PSI[2] to PSI[9] are the value of the corresponding GE port; likewise, when sub-domains from No. 9 to No. 14 are assigned to one FC traffic port, the values of the PSIs from PSI[10] to PSI[15] are the value of the corresponding FC port. The receiving end figures out how many sub-domains there are in this OPUk payload area based on the PSI[1], to which port the sub-domains are assigned based on the values of the PSIs from PSI[2] to PSI[K+1], and then de-maps the information of the sub-domains on the corresponding port. FIG. 8 is a schematic illustrating the filling of data traffic-related information into the reserved bytes in the overhead area of the OTN frame in the above preferred embodiment of the present invention.

In a more common case that the traffic ports are not in a sequential or interleaving order and the corresponding sub-domains of each path of the data traffic are distributed randomly in the OPU payload area, another preferred embodiment of the present invention provides a method for filling the data traffic-related information into the reserved bytes in the OPU overheads, which is as follows:

First, number the sub-domains according to their sequential order in the OTN frame structure, i.e. assign a sub-domain number to each sub-domain.

Then, assign sub-domains randomly to various data traffic, for example, as a path of GE traffic needs 98 sub-domains, No. 1 to No. 10 sub-domains and No. 51 to No. 138 sub-domains are assigned to the GE traffic;

When filling the reserved bytes in the OPU overheads with data traffic-related information, the relationships between sub-domains and data traffic is indicated with PSI areas. When the value of the MFAS is 0, the corresponding PSI[0] indicates the same as described above, i.e., the OPU payload area contains multiple paths of data traffic; when the value of the MFAS is 1, the corresponding PSI[1] indicates the number of sub-domains (K) in the OPU payload area, which is 224 in this embodiment (equal to 0×E0 in hexadecimal system) and the corresponding time slots that are not grouped into any sub-domain can be left unprocessed; when the value of the MFAS is 2, the corresponding PSI[2] indicates the number of the port to which Sub-domain #1 belongs to; when the value of the MFAS is 3, the corresponding PSI[3] indicates the number of the port to which Sub-domain #2 belongs to, the rest can be inferred until when the value of the MFAS is (K+1), the corresponding PSI[K+1] indicates the number of the port to which Sub-domain #K belongs to. Hence any complex mapping relationships of sub-domain groups and data traffic can be shown clearly. FIG. 8 also illustrates the filling of data traffic-related information into the reserved bytes in the overhead area of the OTN frame according to the above preferred embodiment of the present invention.

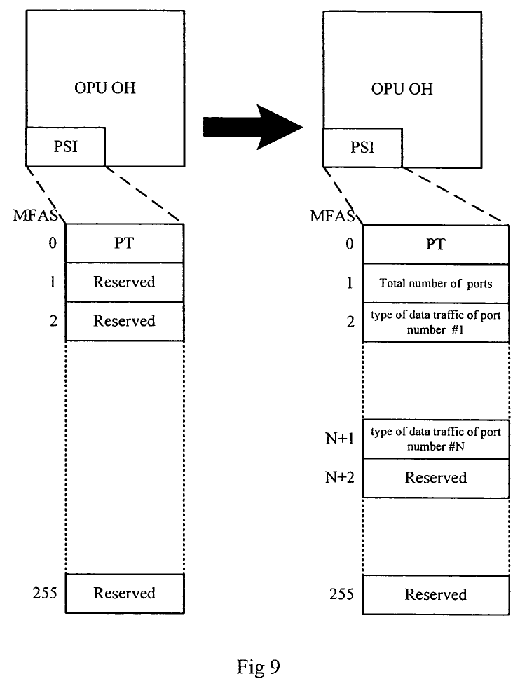

In another simpler embodiment disclosed by the present invention, each OPUk payload column is a sub-domain and an OPUk payload area is divided into the same number of sub-domain groups as the number of the received data traffic and according to the bandwidth demand thereof. Each sub-domain group is assigned with a data traffic port and the GFP encapsulated data traffic are mapped directly into the corresponding sub-domain groups. Neither the bandwidth of a sub-domain group nor the location thereof in the OPUk payload is fixed. The location of a sub-domain group that is corresponding to a path of data traffic is indicated in the OPUk overhead area. FIG. 9 is a schematic diagram illustrating the filling of data traffic-related information into the reserved bytes in the overhead area of the OTN frame according to the above preferred embodiment of the present invention. As it is illustrated in FIG. 9, the overhead can be defined as follows: when the value of MFAS is 0, the corresponding PSI[0] means the same as that in the above description; PSI[1] indicates that the number of received data traffic is N, when a path of GE traffic, a path of FC traffic and 2 paths of ESCON traffic are received, the value of PSI[1] shall be 4, the PSIs from PSI[2] to PSI[N+1] indicate the data traffic types carried by the corresponding sub-domains. The codes for each data traffic type are listed in Table 1:

TABLE 1

| Traffic Type | Code for Traffic Type: PSI[i + 1] Value |
|---|---|
| GE | 0000 0000 (0x00) |
| FE | 0000 0001 (0x01) |
| Ethernet | 0000 0010 (0x02) |
| FC 1G | 0000 0011 (0x03) |
| FC 2G | 0000 0100 (0x04) |
| FC 533 | 0000 0101 (0x05) |
| ESCON | 0000 0110 (0x06) |
| DVB-ASI | 0000 0111 (0x07) |
| . . . | . . . |

The location information of a data traffic in an OPUk payload area, on the other hand, is indicated by other overhead area of the OPUk: the reserved bytes in the first 3 rows of the 15^{th} column are defined as RES1, RES2, RES3, respectively, the combination of the lower 4 bits of RES2 and the 8 bits of RES1 indicate the beginning position of a data traffic in an OPUk payload area which is determined by the MFAS value, the combination of the 8 bits RES3 and the higher 4 bits of RES2 indicate the ending position of the data traffic in an OPUk payload area.

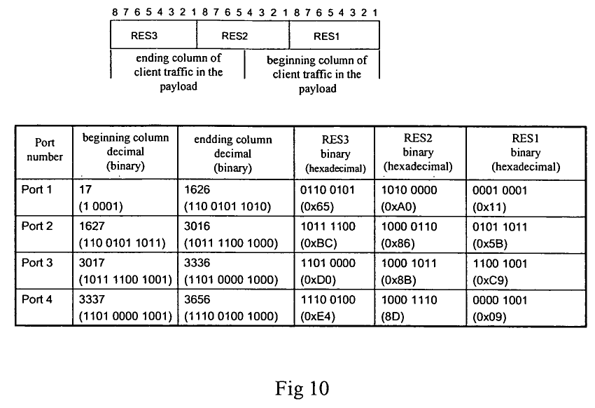

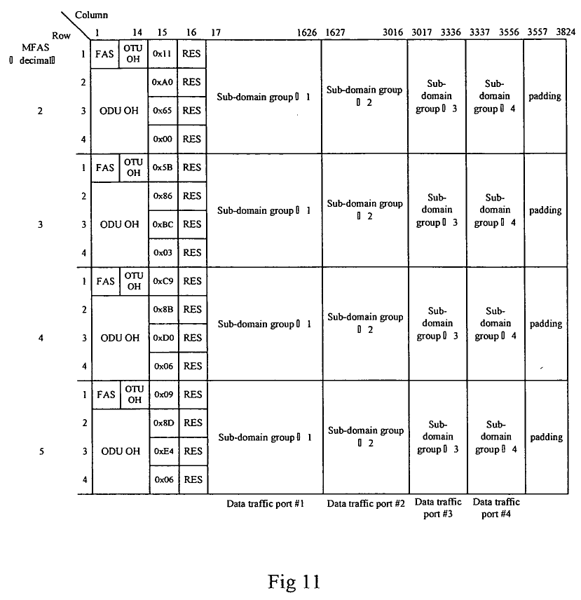

FIG. 10 illustrates the coding information of the beginning position and ending position of the traffic on each port in an OPU1 payload area when a path of GE traffic, an path of FC 1G traffic and 2 paths of ESCON traffic are received: suppose that one GE, one FC 1G and two ESCON data traffic are numbered, respectively, as 1 to 4, and Port #1 to Port 4 stand for the traffic respectively. The bandwidth of GFP encapsulated GE traffic is 1.0495 Gbit/s and the traffic occupies 1.0495G/(2.48832G/3808)≈1607 or approximately 1610 columns in the OPU1 payload area; the bandwidth of GFP encapsulated FC 1G traffic is 906.1899 Mbit/s and the traffic occupies 0.9061899G/(2.48832G/3808)≈1387 or approximately 1390 columns in the OPU1 payload area; and the bandwidth of GFP encapsulated ESCON traffic is 207.5 Mbit/s and the traffic occupy 207.5M/(2.48832G/3808)≈318 or approximately 320 columns in the OPU1 payload area; thus a result as shown in FIG. 9 is obtained. The sub-domain division, overhead allocation and fixed padding for mapping the GE, FC 1G and ESCON data traffic on the OTU1 frame structure are shown in FIG. 11.

The method provided in the embodiment for sub-domain division and direct mapping remarkably increase the traffic transmitting efficiency and bandwidth utilization. For example, in the above embodiment, the bandwidth occupied by a path of GE traffic is 98×11.10857=1088.63986 Mbps and the bandwidth utilization reaches 1000/1088.63986=91.86%; it can be calculated in the same way that the bandwidth utilization of FC and ESCON traffic are 88.97% and 72%, respectively. Compared with the mapping solution through SDH in the prior art, redundant SDH overhead in the intermediate mapping process is reduced in the present embodiment. None of the levels of SDH VCAT, including VC-4-7v (with bandwidth of 1048.32 Mbps), VC-4-6v (with bandwidth of 898.56 Mbps) and VC-3-4v (with bandwidth of 193.536 Mbps) is able to carry GE, FC and ESCON traffic so properly while reaching such high bandwidth utilization. It is obvious that the technical solution provided in the embodiment of the present invention breaks through the bandwidth utilization limit of the OTN data transmission in the prior art.

In an embodiment of the present invention, when multiple low-rate data traffic are to be mapped on the OTN frame structure, GFP multiplexing is conducted first to encapsulate the low-rate data traffic and generate new single high-rate data traffic, and then the multiplexed data traffic are mapped on sub-domains in the above described way and transmitted on the OTN with other high-rate data traffic. Therefore the sub-domain mapping complexity is reduced, the reliability of OTN transmission is improved and the scope of data traffic that an OTN can handle is broadened.

It can be understood by those skilled in the art that the number of time slots allocated in a sub-domain in accordance with the embodiments of the present invention can be configured as any value, the number of the sub-domains assigned in the embodiments to carry various data traffic can be configured as any value, and the method, adopted in the embodiments, for filling data traffic-related information in the reserved bytes of the OTN frame overhead area can adopt any applicable method without affecting the essence and scope of the present invention.

1. A device for transmitting data traffic in an Optical Transport Network (OTN), comprising:
at least one data traffic encapsulating module,
a sub-domain mapping module, and
an OTN framing module; wherein,
the data traffic encapsulating module is configured to encapsulate the data traffic from a client and output the encapsulated data traffic to the sub-domain mapping module;
the sub-domain mapping module is configured to divide the OTN frame payload area into at least one sub-domain, group at least one sub-domain into a sub-domain group, and map the encapsulated data traffic into the sub-domain group before outputting the frame payload to the OTN framing module; and
the OTN framing module is configured to generate an OTN frame based on the OTN frame payload outputted by the sub-domain mapping module.

2. The device according to claim 1, wherein,
the OTN framing module is further configured to analyze the OTN frame received from the OTN and obtains the payloads of the OTN frame;
the sub-domain mapping module is further configured to restore the data traffic from the corresponding sub-domain group of the OTN frame payloads outputted by the OTN framing module; and
the data traffic encapsulating module is further configured to de-map the data traffic received from the sub-domain mapping module and output the traffic to the corresponding client.

3. The device according to claim 1, wherein the sub-domain mapping module divides the OTN frame payload area into at least one sub-domain in a sequential order or through interleaving order.

4. The device according to claim 1, wherein the data traffic encapsulating module encapsulates the data traffic from the corresponding client in the encapsulating mode of Generic Framing Procedure (GFP), or High-speed Data Link Control (HDLC), or Link Access Procedure on Synchronous Digital Hierarchy (SDH).

5. The device according to claim 1, wherein the sub-domain mapping module further comprises an overhead processing sub-module, which fills the overhead area in an optical channel payload unit (OPU) of the OTN frame with data traffic-related information.

6. The device according to claim 2, wherein the sub-domain mapping module further comprises an overhead processing sub-module, which fills the overhead area in the OPU of the OTN frame with data traffic-related information, or analyzes the information from the overhead area in the OPU of the OTN frame to obtain the data traffic-related information; and
the sub-domain mapping module restores the data traffic from the corresponding sub-domain group(s) of the OTN frame payload based on the data traffic-related information.

7. The device according to claim 5, wherein the data traffic-related information comprises: the number of data traffic, the number of sub-domains, the mapping relationship(s) of the sub-domain group(s) and the data traffic, and a piece or a combination of location information of the sub-domain group(s) in the payload area of OPU.

8. The device according to claim 6, wherein the data traffic-related information comprises: the number of data traffic, the number of sub-domains, the mapping relationship(s) of the sub-domain group(s) and the data traffic, and a piece or a combination of location information of the sub-domain group(s) in the payload area of OPU.

9. The device according to claim 5, wherein the overhead area of the OPU comprises: a PSI (Payload Structure Identifier) overhead and a reserved-byte area in the OPU overhead.

10. The device according to claim 6, wherein the overhead area of the OPU comprises: a PSI (Payload Structure Identifier) overhead and a reserved-byte area in the OPU overhead.

11. The device according to claim 9, wherein the overhead processing sub-module matches the values in a multi-frame alignment sequence with data traffic port numbers, identifies the traffic type of each received data traffic by the PSI overhead, and identifies the beginning position and ending position of the data traffic in the payload area of the OTN frame by the reserved byte combination in the OPU overhead.

12. The device according to claim 10, wherein the overhead processing sub-module matches the values in a multi-frame alignment sequence with data traffic port numbers, identifies the traffic type of each received data traffic by the PSI overhead, and identifies the beginning position and ending position of the data traffic in the payload area of the OTN frame by the reserved byte combination in the OPU overhead.

13. The device according to claim 5, wherein the overhead area of the OPU comprises the PSI overhead in the OPU overhead.

14. The device according to claim 6, wherein the overhead area of the OPU comprises the PSI overhead in the OPU overhead.

15. The device according to claim 13, wherein the overhead processing sub-module matches the values in a multi-frame alignment sequence with the data traffic port numbers and for each path of the data traffic received, and the number of the sub-domains occupied by the data traffic is indicated by the PSI overhead.

16. The device according to claim 14, wherein the overhead processing sub-module matches the values in a multi-frame alignment sequence with the data traffic port numbers and for each path of the data traffic received, and the number of the sub-domains occupied by the data traffic is indicated by the PSI overhead.

17. The device according to claim 13, wherein the overhead processing sub-module matches the values in a multi-frame alignment sequence with the sub-domain numbers and for each sub-domain, the data traffic port to which the sub-domain is assigned is indicated by the PSI overhead.

18. The device according to claim 14, wherein the overhead processing sub-module matches the values in a multi-frame alignment sequence with the sub-domain numbers and for each sub-domain, the data traffic port to which the sub-domain is assigned is indicated by the PSI overhead.

19. A device for receiving data traffic transmission in an Optical Transport Network (OTN), comprising:
an OTN framing module,
a sub-domain mapping module, and
at least one data traffic encapsulating module, wherein
the OTN framing module is configured to analyze the OTN frame received from OTN and obtain the payloads of the OTN frame;
the sub-domain mapping module is configured to restore the data traffic from the corresponding sub-domain group(s) of the OTN frame payloads which are outputted from the OTN framing module; and
the data traffic encapsulating module is configured to de-encapsulate the data traffic from the sub-domain mapping module and output the data traffic to a corresponding client.

20. The device according to claim 19, wherein the sub-domain mapping module further comprises:
an overhead processing sub-module, which analyzes information from the overhead area of an optical channel payload unit (OPU) of the OTN frame to obtain the data traffic-related information; and, the sub-domain mapping module restores the data traffic from the corresponding sub-domain group(s) of the OTN frame payload based on the data traffic-related information.

21. A method for data traffic transmission in an Optical Transport Network (OTN), comprising:
dividing an OTN frame payload area into at least one sub-domain; and
encapsulating a single or multiple data traffic from client(s), and mapping the encapsulated data traffic, respectively, on one or more sub-domain groups which comprise at least one sub-domain, wherein the sub-domain group(s) carries(carry) the data traffic, respectively, and forms(form) an OTN frame.

22. The method according to claim 21, wherein the step of dividing the OTN frame payload area into at least one sub-domain comprises:
dividing the OTN frame payload area into at least one sub-domain, each of which comprises at least one OTN payload column and occupies part of the entire bandwidth of the OTN frame payload area.

23. The method according to claim 22, wherein the sub-domain(s) is(are) distributed in the OTN frame payload domain sequentially or through interleaving.

24. The method according to claim 21, wherein the encapsulating process is conducted in the encapsulating mode of generic framing procedure, or in the encapsulating mode of high-speed data link control, or in the encapsulating mode of link access procedure on SDH.

25. The method according to claim 21, wherein the bandwidth of each sub-domain group is no less than the bandwidth of the corresponding encapsulated data traffic.

26. The method according to claim 21, further comprising:
when the bandwidth of the encapsulated data traffic is less than the bandwidth of the corresponding sub-domain group, inserting idle frames or the padding bytes corresponding to the encapsulating mode to adapt the bandwidth of the encapsulated data traffic to the bandwidth of the corresponding sub-domain group.

27. The method according to claim 21, further comprising:
filling the OTN frame overhead with the data traffic-related information.

28. The method according to claim 27, wherein the data traffic-related information comprises: the number of the data traffic, the number of the sub-domains, the mapping relationship(s) of the sub-domain group(s) and the data traffic, and the location information of sub-domain groups in the payload area of OPUs.

29. The method according to claim 27, wherein the OTN frame overhead comprises PSI overhead and the reserved bytes in an optical channel payload unit (OPU) overhead.

30. The method according to claim 29, wherein the step of filling the OTN frame overhead with the data traffic-related information comprises:
matching the values in a multi-frame alignment sequence with the port numbers of the inputted data traffic;
identifying the traffic type of each inputted data traffic by the PSI overhead; and
identifying the beginning location and ending location of each path of the inputted data traffic in the payload area of the OTN frame by the reserved byte combination in the OPU overhead.

31. The method according to claim 29, wherein the OTN frame overhead comprises PSI overhead in the OPU overhead.

32. The method according to claim 31, wherein the step of filling the OTN frame overhead with the data traffic-related information comprises:
matching the values in a multi-frame alignment sequence with the port numbers of the inputted data traffic and for each inputted data traffic,
indicating the number of the sub-domains occupied by the data traffic with the PSI overhead.

33. The method according to claim 31, wherein the step of filling the OTN frame overhead with the data traffic-related information comprises:
matching the values in a multi-frame alignment sequence to the sub-domain numbers and for each sub-domain,
identifying by the PSI overhead the data traffic port to which the sub-domain is assigned.

34. The method according to claim 21, further comprising:
using fixed padding in the part of the payload area which has not been used to constitute the sub-domains and in the sub-domains which do not carry the data traffic.

35. The method according to claim 21, wherein the encapsulating is the GFP encapsulating; and
the method further comprises: adding corresponding channel identifiers in the GFP encapsulating process based on the data traffic ports.

36. The method according to claim 21, further comprising in the receiving direction:
de-framing the OTN frame received;
restoring at least one path of data traffic from at least one sub-domain group contained in the OTN frame payload area; and
de-encapsulating the at least one path of data traffic before sending the data traffic to corresponding client(s), respectively.

37. The method according to claim 36, further comprising:
separating the OTN frame overhead from the OTN frame received;
obtaining the data traffic-related information from the OTN frame overhead; and
restoring at least one path of data traffic from at least one sub-domain group contained in the OTN frame payload area according to the data traffic-related information.

38. The method according to claim 36, further comprising:
leaving unprocessed the part of the payload area which has not been used to constitute the sub-domains and the sub-domains which do not carry the data traffic.

39. The method according to claim 36, further comprising:
verifying the restoration of each path of the data traffic with the channel identifiers in the GFP frame.

40. A method for receiving data traffic transmission in an Optical Transport Network (OTN), comprising:
de-framing the OTN frame received;
restoring at least one path of data traffic from at least one sub-domain group contained in the payload area of the OTN frame; and
de-encapsulating the at least one path of data traffic before transmitting the data traffic to corresponding client(s), respectively.

41. The method according to claim 40, further comprising:
separating the OTN frame overhead from the OTN frame received;
obtaining the data traffic-related information from the OTN frame overhead, and
restoring at least one path of data traffic from at least one sub-domain group contained in the payload area of the OTN frame according to the data traffic-related information.

42. The method according to claim 41, wherein the data traffic-related information comprises the number of the data traffic, the number of the sub-domains, the mapping relationship(s) of the sub-domain group(s) and the data traffic, and the location information of the sub-domain groups in the payload area of the OPU.

43. The method according to claim 40, further comprising:
leaving unprocessed the part of the payload area which has not been used to constitute the sub-domains and the sub-domains which do not carry the data traffic.

44. The method according to claim 40, further comprising:
verifying the restoration of each path of the data traffic with the channel identifiers in the GFP frame.
